(19) United States
(12) Patent Application Publication
(10) Pub. No.: US 2023/0032312 A1
(43) Pub. Date: Feb. 2, 2023

(54) Apparatus, System and Method for Automatic Livestock Feeding

(71) Applicant: Barry Smith, Hereford, TX (US)

(72) Inventor: Barry Smith, Hereford, TX (US)

(21) Appl. No.: 17/572,732

(22) Filed: Jan. 11, 2022

Related U.S. Application Data
(60) Provisional application No. 63/226,943, filed on Jul. 29, 2021.

(51) Int. Cl. A01K 5/02; A01M 31/00

(52) U.S. Cl. CPC A01K 5/0291; A01K 5/0225; A01K 5/0275; A01M 31/008

(57) ABSTRACT

This present invention relates to a novel automated and timer-based livestock, game, animal or bird feeding station. The feeding station is configured to connect to a software application installed in a handheld electronic device or to a wireless communication remote through a wireless communication channel. The feeding station includes a timer configured to a timer value and a frequency at which the station dispenses the feed/corn. The feeding station also provides an alert to the software application indicating low volume of feed in the feeding station and an audible alert for livestock to indicate that a feed is ready. A central storage can replenish the feed in the storage area of a plurality of feeding stations.

### CROSS-REFERENCE TO RELATED APPLICATION

The present application claims priority to, and the benefit of, U.S. Provisional Application No. 63/226,943, which was filed on Jul. 29, 2021 and is incorporated herein by reference in its entirety.

### FIELD OF THE INVENTION

The present invention relates generally to the field of animal feeding stations. More specifically, the present invention relates to an automated or autonomous and time-based livestock feeding station that can be positioned in a farm, hunting area or more. The feeding station is configured to release corn or feed for livestock at preconfigured times in an automated manner. A wireless communication remote or an electronic device having a software application can be used for remotely operating the feeding station. The feeding station generates audible alerts for livestock to alert same about a dispensed feed. The station saves extensive time and effort when using corn feeders on farms, in hunting areas and more. Accordingly, the present disclosure makes specific reference thereto. Nonetheless, it is to be appreciated that aspects of the present invention are also equally applicable to other like applications, devices and methods of manufacture.

### BACKGROUND

By way of background, animal feed is food given to domestic animals, especially livestock, in the course of animal husbandry. Corn is the most important grain used as livestock feed in the world. Corn starch is nearly 100% digestible and can be augmented by grain processing. Generally, livestock animals graze around in a farm, pasture, field or the like, but this is highly ineffective and can cause nutrition deficiency in animals. Wild animals can be fed with animal feeder stations in hunting areas, habitat areas, game trail areas or the like, in order to supplement natural food sources and/or to attract game to specific areas.

Some individuals use feeding stations for providing feeds to domesticated/livestock animals. These stations store feed and dispense it upon the actions of users. However, individuals have to manually dispense feed from the feeder stations, and this is not only time-consuming and laborious, but accidentally leaves behind human scent when dispensing from standard feeders. In cases, where a plurality of feeders is positioned in one or more areas, dispensing can be delayed due to inefficiency of physically operating each feeder station, which is time-consuming. Human scent or human odor is detrimental when attempting to attract wild animals to feeder stations and can also result in less interaction of livestock animals with the feeder station.

In some cases, individuals may neglect to dispense feed at the required time because they forget or are occupied with other work activities. This leads to loss of feed to animals which can cause restlessness in the animals. Individuals desire a way to feed animals so that animals don't miss their feed while also maintaining a feeding routine and a consistent feed quantity being dispensed.

Generally, individuals shout or gather animals for feeding which is time-consuming and inefficient. Some animals may miss their feed if they can't hear the sound or signal for their feed.

Therefore, there exists a long felt need in the art for an improved animal feeding station that can automatically dispense animal feed. There is also a long felt need in the art for a feeding station that allows users to remotely operate the feeding station without physically being present at the station. Additionally, there is a long felt need in the art for a livestock feeding station that dispenses feed at preconfigured times or intervals automatically. Moreover, there is a long felt need in the art for an improved feeding station that alerts animals for their feed. Furthermore, there is a long felt need in the art for an animal feeding station that maintains effective nutrition of animals. Finally, there is a long felt need in the art for an improved feeding station that saves extensive time and effort of individuals when using feeders on farms, in hunting areas and other feeding areas.

The subject matter disclosed and claimed herein, in one embodiment thereof, comprises a livestock or wild animal feeding station. The livestock feeding station releases corn/feed for feeding livestock, deer, and other animals. The feeding station includes a storage area for storing feed for livestock/animals/birds, a releasing slot for dispensing feed through a conduit, and an inlet for storing feed in the storage area. The feeding station also includes a timer that is configured to one or more timer values, a wireless transceiver for establishing a wireless communication channel with a remote device, a motor for actuating a metering tray to release feed through the releasing slot, a processor, a weight sensor for measuring weight of the feed stored in the storage area; wherein the station is configured to automatically dispense feed at the preconfigured times and upon receiving an actuation command from the remote device.

In this manner, the livestock feeding station of the present invention accomplishes all of the forgoing objectives and provides users with an improved feeding station that automatically dispenses feed/corn at specified times and also dispenses when actuated remotely by a user. The station alerts livestock and provides an effective means for providing feed. A paired smartphone application enables users to remotely operate the station obviating human scent near the station and thus making the feeding process more effective and efficient.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a livestock and animal feeding station. The livestock/animal feeding station is designed as an automated or autonomous, time-based feeding system designed to release corn/feed for feeding livestock, deer and other animals. The feeding station further comprises a storage area for storing feed for livestock/animals/birds, a releasing slot for dispensing feed through a conduit, an inlet for storing feed in the storage area, a control unit integrated to the station and comprising a timer configured to one or more timer values or intervals, a wireless transceiver for establishing a wireless communication channel with a remote device, a speaker for producing an audible alert, a motor for actuating a metering tray to release feed through the releasing slot, a processor, a camera for capturing surroundings of the station wherein the station and the remote device are wirelessly coupled; wherein the station is configured to automatically dispense feed on the preconfigured times or intervals upon receiving an actuation command from the remote device.

In yet another embodiment, the control unit also includes a weight sensor or volume sensor that determines the weight or volume of the feed in the storage area and the processor compares the determined value with a predefined threshold.

In yet another embodiment, the remote device can be a handheld electronic device having a processor or a wireless communication remote that comes integrated with the feeding station.

In yet another embodiment, a computer-implemented feeding station application is installed in the electronic device and is configured to control the feeding station.

In yet another embodiment, the processor of the feeding station receives an actuation command from the software application for instantly dispensing feed for animals.

The subject matter disclosed and claimed herein, in another embodiment thereof, comprises a wireless animal feeding system. The wireless animal feeding system includes a feeding station communicatively-coupled to a computer-implemented feeding station application installed in a handheld electronic device. The feeding station is configured to automatically dispense feed/corn for livestock/animals/birds and to transmit an alert of low feed availability in the feeding station to the coupled computer-implemented application. The computer-implemented application enables a user to transmit an actuation signal to activate dispensing of feed from the feeding station, configure the timer of the feeding station and view a live video captured by the camera of the feeding station.

In yet another embodiment, a method for automatically dispensing of corn for livestock/animals/birds from a feeding station is disclosed. The method includes the steps of: configuring a timer of the station with a timer value, interval and/or frequency at which the corn/feed is automatically dispensed; receiving by a processor of the station, the timer value from the timer for performing a corn release instruction, wherein the corn is also automatically dispensed upon receiving the timer value(s) by the processor; and, actuating a command from a wireless communication remote or from a feeding station software application installed in a handheld electronic device.

Yet another method of the present invention further comprises a feeding station generating an audible alert for livestock indicating that feed is available for them.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an automated or autonomous animal feeding station of the present invention in accordance with the disclosed architecture;

FIG. 2 illustrates a connection diagram showing the connections between the electronic components of one potential embodiment of the automated or autonomous animal feeding station of the present invention in accordance with the disclosed architecture;

FIG. 3 illustrates a schematic view of the communication of the livestock feeding station with the livestock feeding application and the wireless communication remote in accordance with the disclosed architecture;

FIG. 4 illustrates a flow diagram showing exemplary steps of configuring the animal feeding station remotely using the software application in accordance with the disclosed architecture;

FIG. 5 illustrates a flow diagram showing the processing of a remote actuation command sent from the software application or the wireless communication remote for dispensing the feed from one potential embodiment of the animal feeding station of the present invention in accordance with the disclosed architecture;

FIG. 6 illustrates a perspective view showing an animal eating corn dispensed from one potential embodiment of the animal feeding station of the present invention in accordance with the disclosed architecture;

FIG. 7 illustrates an exemplary electronic device in which the animal feeding station software application of the present disclosure is installed in accordance with the disclosed architecture; and

FIG. 8 illustrates a perspective view showing a central corn storage connected to a plurality of feeding stations of the present invention for automatically replenishing feed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved animal feeding station that can automatically dispense animal feed. There is also a long felt need in the art for a feeding station that allows users to remotely operate the feeding station without physically being present at the station. Additionally, there is a long felt need in the art for a livestock feeding station that dispenses feed at preconfigured times or intervals automatically. Moreover, there is a long felt need in the art for an improved feeding station that alerts animals for their feed. Furthermore, there is a long felt need in the art for an animal feeding station that maintains effective nutrition of animals. Finally, there is a long felt need in the art for an improved feeding station that saves extensive time and effort of individuals when using feeders on farms, in hunting areas and other feeding areas.

The present invention, in one exemplary embodiment, is a novel automated or autonomous and time-based animal feeding system. The animal feeding system includes a feeding station communicatively-coupled to a computer-implemented feeding station application installed in a handheld electronic device. The feeding station is configured to automatically dispense feed/corn for livestock/animals/birds, and transmit an alert of low feed availability in the feeding station to the coupled computer-implemented application. The computer-implemented application enables a user to transmit an actuation signal to activate dispensing of feed from the feeding station, configure a timer of the feeding station, and view a live video captured by a camera of the feeding station.

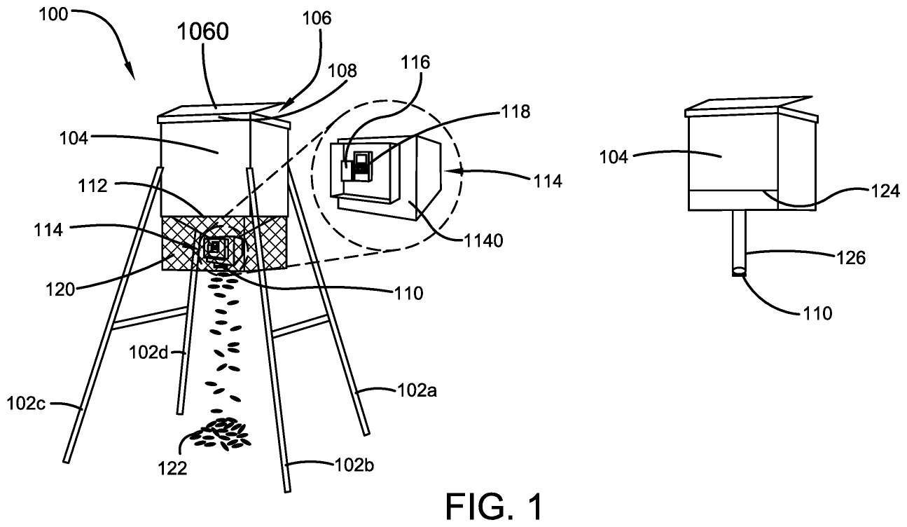

Referring initially to the drawings, FIG. 1 illustrates a perspective view of one potential embodiment of an automated or autonomous livestock feeding station of the present invention in accordance with the disclosed architecture. FIG. 1 shows several advantageous features of the present invention, but as will be described in more detail below, the invention can be provided in several shapes, sizes, combinations of features and components, and varying numbers and functions of the components. The automated or autonomous livestock/animal feeding station 100 is a time-based feeding station designed to release corn or other feeding items for feeding livestock, deer, birds and other animals. The feeder station 100 obviates the need of a user to manually provide feed to the livestock and saves extensive time and effort when using the feeder stations 100 on farms, in hunting areas, game trail areas, bird nesting areas and more. More specifically, the feeding station 100 is a standalone device that can be placed securely on any generally level surface on a farm, hunting area, bird area or more, using the legs 102a,102b,102c,102d. The legs 102a,102b,102c,102d provide adequate support and stabilize the station 100 even when it is hit by an animal or subjected to inclement weather. A feed or corn storage 104 is configured to store the feed for livestock/animals/birds and includes an inlet 106 at the top end 108 through which the feed is stored in the storage area 104. The inlet 106 is covered by a hinged door 1060 to cover the stored feed.

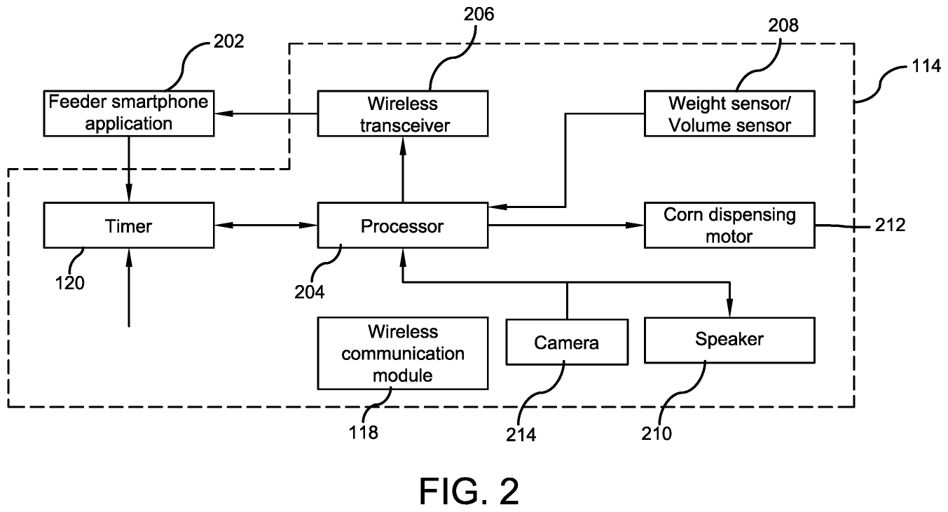

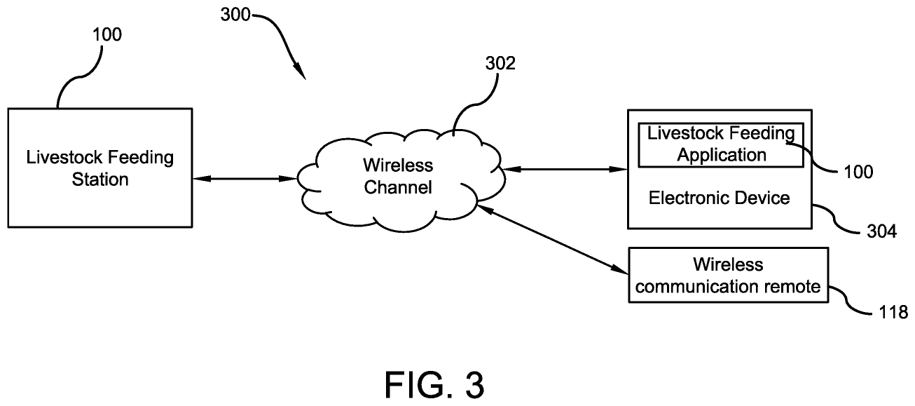

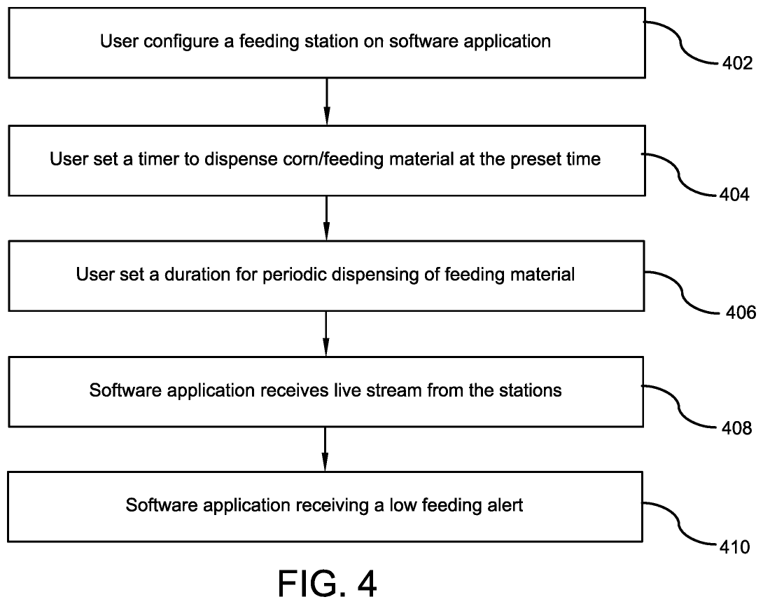

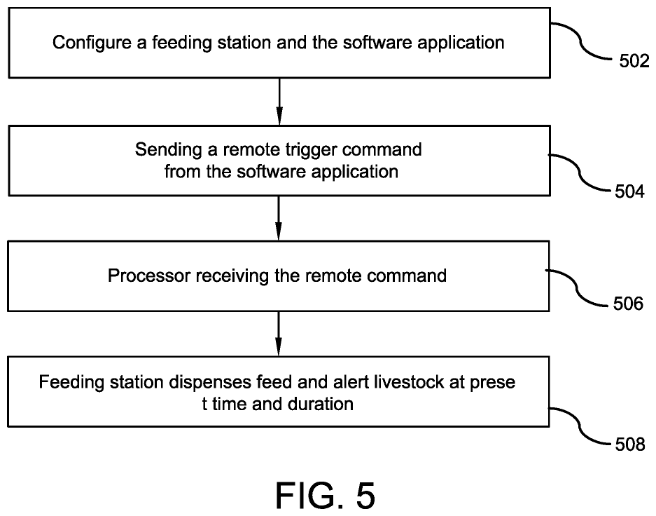

An outlet 110 is disposed at the bottom 112 through which the corn or feed is dispensed from the storage area 104. A central control unit 114 is placed, preferably underneath the storage area 104 and is responsible for performing automated or autonomous functions of the station including automated dispensing of corn or feed, generating alerts for the livestock (as described in FIG. 4) and wirelessly communicating with a remote electronic device (as best shown in FIG. 3). More specifically, the control unit 114 includes internal electronic components that are controlled by a processor of the control unit 114. The control unit 114 includes a timer 116 that can be configured by a user such as a farmer or hunter using the wireless remote 118 or using a feeding station control smartphone application installed in an electronic device (shown in FIG. 3). The timer 116 and the wireless remote 118 are positioned on the exterior surface 1140 of the control unit 114 whereas other components (described in FIG. 2) are positioned inside the control unit 114 and are connected to each other through a wired circuit (not shown). The control unit 114 can be safeguarded by a metal grill 120, wherein the metal grill 120 can be removed by a user in case the control unit 114 needs any repair. There can be a small removable portion in the metal grill 120, thereby allowing a user such as a farmer or hunter to access the wireless remote 118 for configuring the timer 116. The preconfigured timing value of the timer 116 is used by the feeding station 100 for dispensing the feed 122 automatically onto or over the ground, preferably between the legs 102a-d which can alternatively be termed as the feed delivery area. It should be appreciated that a user can pre-set the timer value and then the station 100 automatically dispenses the feed 122 without any manual intervention of the user. Also, if required, a user can remotely actuate instant or immediate dispensing of the feed (as shown in FIG. 5).

In use, the feeding station 100 is positioned at each feed point. The storage area 104 includes a metering tray 124 at the bottom which is actuated by a motor (shown in FIG. 2) based on the timing value or timing intervals of the timer 116. When the metering tray 124 is actuated, a predefined weight or amount of the feed 122 is dispensed from the storage area 104. A conduit 126 is connected to the outlet 110 that allows dispensing of the feed in an effective manner onto the ground positioned below the storage area 104 and the control unit 114 which allows the livestock to easily eat the feed. The feeding station 100 improves the general health of livestock while reducing the dependency on users for providing feed at regular intervals.

FIG. 2 illustrates a connection diagram showing the connections between the electronic components of the feeding station of the present invention in accordance with the disclosed architecture. As stated earlier, the control unit 114 of the station 100 includes a plurality of components that are used for automatically dispensing feed in a controlled manner. The timer 116 is preconfigured with a timer value and an optional frequency value using either a feeder smartphone application 202 installed in an electronic device or through the wireless remote 118. The configured timer value of the timer 116 is accessed by the processor 204 of the station 100. The processor 204 is designed as a specialized processor which can be a software-programmable processor. An integrated wireless transceiver 206 is used for enabling communication of the station 100 and the feeder smartphone application 202. The wireless transceiver 206 establishes a wireless communication channel for enabling the smartphone application 202 and wireless remote 118 to remotely control the station 100.

For detecting the volume of feed available in the storage area of the station 100, a weight sensor or volume sensor 208, or both, can be integrated in the storage area. The weight sensor/volume sensor 208 detects the weight/volume of the feed in the storage area and provides the information to the processor 204. The processor 204 can determine that the detected weight/volume is less than a predefined threshold such as, for example, 10% of total storage of the storage area, an alert may be sent by the processor 204 to the software application 202. The sensors may be based on at least one or more sensor technology for example including, but not limited to, optical, piezoelectric, mechanical, capacitance, magnetic, RF, MEMS, or the like technology, sensor technology for determining weight and/or volume of feed.

An integrated speaker 210 can be disposed withing the electronic components for creating an audio alert for livestock/animals/birds when the processor 204 activates the feed/corn dispensing motor 212 to dispense the feed. The speaker 210 is used for alerting the livestock/animals/birds about a dispensed feed and can be any piezoelectric, capacitive or mechanical speaker. The dispensing motor 212 is used for actuating the metering tray 124 for dispensing feed through the outlet 110 via the conduit 126. The dispensing motor 212 receives a signal from the processor 204 at the preconfigured time or interval for dispensing a feed for livestock. A camera 214 can be disposed on the exterior surface of the control unit 114 and can be used for recording and live streaming the surroundings of the station 100. The live streaming is transmitted to the software application 202 and can be viewed by the user to see if there are any animals roaming around the station 100 for feed at a time not configured for the feeding. In such cases, a remote actuation command can be received by the processor 204 from the software application 202 for instantly dispensing the feed.

FIG. 3 illustrates a schematic view of the communication of the livestock feeding station 100 with the livestock feeding application 202 and the wireless communication remote 118 in accordance with the disclosed architecture. An advantage of the livestock feeding station 100 is that it can be remotely operated and configured by a user for dispensing feed for livestock in a feeding system 300. More specifically, the livestock feeding station 100 is in wireless communication with an electronic device 304 having the installed livestock feeding application 202 enabling a user to configure and remotely operate the station 100. Similarly, the station 100 can communicate with the wireless communication remote 118 for wireless control of the station 100. A wireless communication channel 302 is used for communication between the station 100 and electronic device 304 and wireless communication remote 118.

The wireless communication channel 302 may be of any local area network (LAN), metropolitan area network (MAN), wide area network (WAN), a public data network (e.g., the Internet), short range wireless network and the like, or any combination thereof established by the wireless transceiver 206. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), Wi-Fi Direct, wireless LAN (WLAN), Bluetooth®, mobile ad-hoc network (MANET) and the like, or any combination thereof.

Wireless instructions from the livestock feeding application are received by the processor of the station 100 and accordingly, instructions are provided to one or more components described in FIG. 2 for dispensing feed. The livestock feeding application 202 provides a plurality of control options to view and monitor surrounding of the station 100. The application 202 can be updated periodically to include new features and can be downloaded using the Internet from an application play store such as Google play store or Apple store. The livestock feeding application 202 also provides notifications when the weight/volume of the feed in the storage area 104 is less than a threshold, thereby enabling the user to refill the feed.

It should be appreciated that both the application 202 and the wireless remote 118 allows hunters to remotely actuate the station 100 or set a timer to release corn/feed, thus obviating the worry of accidentally leaving behind human scent near the station 100 when dispensing feed. Further, the system limits corn/feed waste and the feed can be dispensed in a limited volume at pre-defined times.

FIG. 4 illustrates a flow diagram showing exemplary steps of configuring a feeding station 100 remotely using the software application 202 in accordance with the disclosed architecture. Initially, a user such as a hunter configures a feeding station in the software application (Step 402). More than one feeding station can be configured in the software application 202 that allows a user to selectively monitor and operate the feeding stations positioned at multiple feeding sites on farms, hunting areas, bird and duck areas and more. Once the feeding stations are configured, a timer can be set for each individual feeding station at which the feeding stations dispense the corn/feed for livestock/game/birds (Step 404). In addition to time, the user can configure a frequency or interval such as 1 hour, 2 hours, or more for periodic dispensing of the feed (Step 406). The feeding software application receives images or video streaming from individual feeding stations which can be viewed by the user for reviewing surroundings of the stations (Step 408). The aforementioned viewing can be used to enable a user to make decisions for remote actuating of any of the stations for dispensing feed. When the feed stored in the station becomes less than a threshold value, then the software application receives an alert from the respective station and can be used for refilling the stations (Step 410).

FIG. 5 illustrates a flow diagram showing the processing of the remote actuation command sent from the software application 202 or the wireless communication remote 118 for dispensing the feed from the station 100 in accordance with the disclosed architecture. Initially, in case of a software application, the feeding station software application is configured with at least one feeding station (Step 502). In case of a wireless communication remote, the remote and the station are preconfigured to connect with each other. Then, as per the need and desire of the user, a remote actuation command is transmitted from the software application/remote to the station (Step 504). Thereafter, the processor of the station receives the remote actuation command and activates dispensing of the feed (Step 506). Finally, while dispensing the feed, the station also alerts the nearby livestock/animals/birds about the feed dispensing by generating an audible alarm, for example (Step 508).

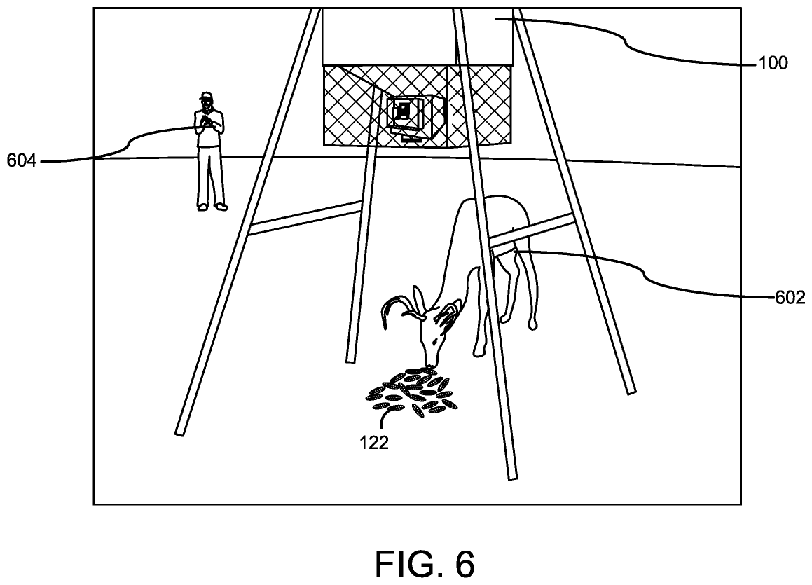

FIG. 6 illustrates a perspective view showing an animal eating corn 122 dispensed from the station 100 in accordance with the disclosed architecture. When feed or corn 122 is dispensed by the station 100, an alert is also generated by the speaker of the station 100. The audible alert is used for alerting livestock animals 602 that a feed is available and the livestock animals 602 gather under the station 100 to have the dispensed feed. A remote user 604 can view the live video on the software application 202 and can also remotely actuate dispensing of feed in case there is a requirement of additional feed for the animals 602. The user can change the frequency or interval, as well as time for dispensing the feed.

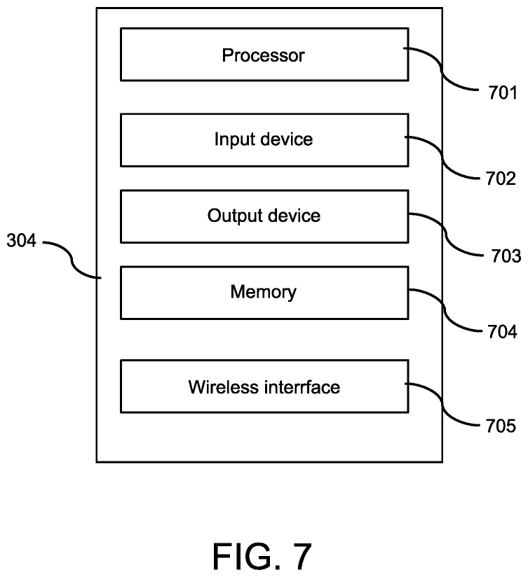

FIG. 7 illustrates an exemplary electronic device 304 in which the feeding station software application 202 of the present disclosure is installed in accordance with the disclosed architecture. The electronic device 304 includes several components such as a processor 701 configured to perform one or more functions described herein in accordance with the computer-implemented instructions. The electronic device 304 includes input device(s) 702 such as a mouse, keyboard, touch input device, voice input device, etc. for entering data and information. The electronic device 304 also includes one or more output device(s) 703 such as a monitor, presence-sensitive display or other display device. The electronic device 304 includes memory 704 used for storing programs (sequences of instructions) or data (e.g., program state information) on a temporary or permanent basis for use in the computer system. Memory 704 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 701, in combination with one or more of memory 704, input device(s) 702 and output device(s) 703, is utilized to enable users to remotely configure, activate, and perform other functions for the feeding station 100. The wireless connection with the feeding station 100 is provided by a wireless interface 705. It should be appreciated that same components and functionality are present in the wireless communication remote 118.

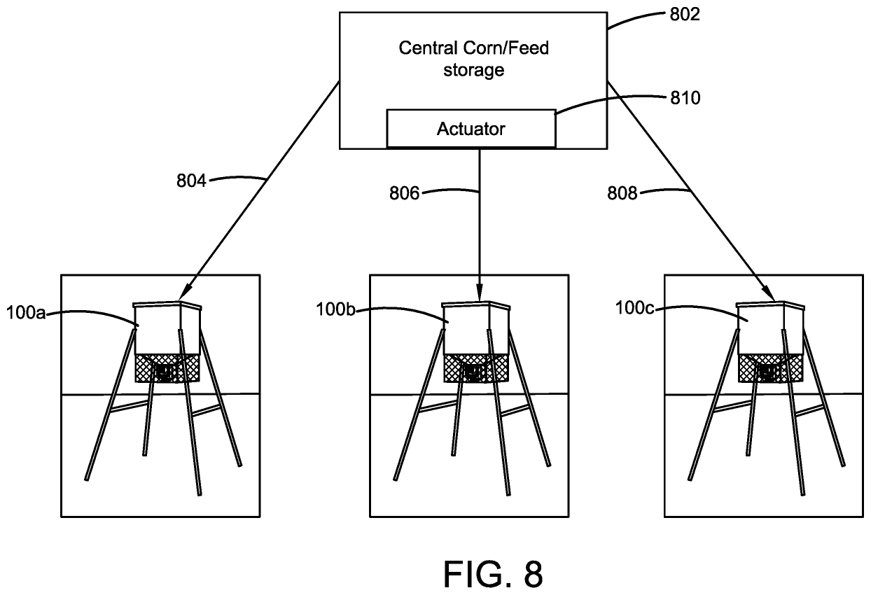

FIG. 8 illustrates a perspective view showing a central feed/corn storage connected to a plurality of feeding stations of the present invention for automatically replenishing feed in accordance with the disclosed architecture. In the present embodiment, the storage area of individual feeding stations 100a, 100b, 100c are connected to the central storage 802 through respective storage conduits 804, 806, 808. The central storage 802 is configured to receive an alert from the processor of the feeding station whose storage area has less feed than a threshold (as described in FIG. 2) and then the actuator 810 of the central storage 802 initiates transfer of feed/corn to the storage area of the feeding station for automatically replenishing the feed/corn. This obviates the requirement of a user to replenish individual feeding stations and thus saves time. Also, it eliminates accidentally leaving behind human scent when filling feeders 100a,100b,100c. It should be noted that a transfer means such as a conveyer belt (not shown) or a pressure difference can be used for transferring feed/corn from the central storage 802 to the feeding stations.

Although the present invention is described with regard to a “computer or electronic device” it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, a robot, an android or the like. Any two or more of such devices in communication with each other, and/or any computer in communication with any other computer or device comprising a processor, may optionally comprise a “computer network”.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “feeding station”, “livestock feeding station”, “automated or autonomous and time-based feeding station”, and “station” are interchangeable and refer to the automated and time-based feeding station 100 of the present invention.

Notwithstanding the forgoing, the automated or autonomous and time-based feeding station 100 of the present invention can be of any suitable size and configuration as is known in the art without affecting the overall concept of the invention, provided that it accomplishes the above-stated objectives. One of ordinary skill in the art will appreciate that the size, configuration and material of the automated and time-based feeding station 100 as shown in the FIGS. are for illustrative purposes only, and that many other sizes and shapes of the automated and time-based feeding station 100 are well within the scope of the present disclosure. Although the dimensions of the automated and time-based feeding station 100 are important design parameters for user convenience, the automated and time-based feeding station 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An autonomous animal feeding station comprising:
a time actuated feeding station including a plurality of legs wherein said feeding station including a feed storage for storing feed for the animals including an inlet at a top end for receiving the feed therethrough and an outlet at a bottom end through which the feed is dispensed from said feed storage;
a central control unit for performing autonomous functions of said feeding station including autonomous dispensing of the feed;
an alert for audibly signaling said dispensing of the feed;
a wireless remote electronic device for communicating with said central control unit of said feeding station; and
wherein said autonomous functions include a timer for dispensing the feed at predeterminable intervals.

2. The autonomous animal feeding station of claim 1, wherein said autonomous functions include a metering tray at a bottom of said feed storage for dispensing the feed at predeterminable volumes.

3. The autonomous animal feeding station of claim 2, wherein said wireless remote electronic device is a smartphone.

4. The autonomous animal feeding station of claim 3, wherein said feed storage includes a weight sensor for determining a weight of the feed remaining in said feed storage.

5. The autonomous animal feeding station of claim 4, wherein said central control unit alerts said wireless remote electronic device when said weight of the feed remaining in said feed storage is less than a predeterminable threshold weight.

6. The autonomous animal feeding station of claim 3, wherein said feed storage includes a volume sensor for determining a volume of the feed remaining in said feed storage.

7. The autonomous animal feeding station of claim 6, wherein said central control unit alerts said wireless remote electronic device when said volume of the feed remaining in said feed storage is less than a predeterminable threshold volume.

8. The autonomous animal feeding station of claim 1, wherein said predeterminable intervals are predeterminable times.

9. The autonomous animal feeding station of claim 1, wherein at least one of said predeterminable intervals is a remote actuation of an immediate dispensing of the feed.

10. An autonomous animal feeding station comprising:
a time actuated feeding station including a plurality of legs wherein said feeding station including a feed storage for storing feed for the animals including an inlet at a top end for receiving the feed therethrough and an outlet at a bottom end through which the feed is dispensed from said feed storage;
a central control unit for performing autonomous functions of said feeding station including autonomous dispensing of the feed;
a wireless remote electronic device for communicating with said central control unit of said feeding station;
wherein said autonomous functions include a timer for dispensing the feed at predeterminable intervals;
wherein said feed storage includes a volume sensor for determining a volume of the feed remaining in said feed storage; and
wherein said central control unit alerts said wireless remote electronic device when said volume of the feed remaining in said feed storage is less than a predeterminable threshold volume.

11. The autonomous animal feeding station of claim 10, wherein said autonomous functions include a metering tray at a bottom of said feed storage for dispensing the feed at predeterminable volumes.

12. The autonomous animal feeding station of claim 10, wherein said wireless remote electronic device is a smartphone.

13. The autonomous animal feeding station of claim 10, wherein said central control unit includes a camera for live streaming the surrounding area of said feeding station to said wireless remote electronic device.

14. The autonomous animal feeding station of claim 10, wherein said predeterminable intervals are predeterminable times.

15. The autonomous animal feeding station of claim 10, wherein at least one of said predeterminable intervals is a remote actuation of an immediate dispensing of the feed.

16. The autonomous animal feeding station of claim 10, further comprising an alert for audibly signaling said dispensing of the feed.

17. An autonomous animal feeding station system comprising:
a plurality of time actuated feeding stations wherein each said feeding station including a plurality of legs and a feed storage for storing feed for the animals including an inlet at a top end for receiving the feed therethrough and an outlet at a bottom end through which the feed is dispensed from said feed storage;
a central feed storage for selectively transferring feed from said central feed storage to said inlet at a top end of each said plurality of time actuated feeding stations;
a central control unit for performing autonomous functions of each said plurality of time actuated feeding stations including autonomous dispensing of the feed;
wherein said autonomous functions include a timer for dispensing the feed at predeterminable intervals;
wherein said feed storage of each said plurality of time actuated feeding stations include a volume sensor for determining a volume of the feed remaining in said feed storage; and
wherein said central control unit alerts said central feed storage when said volume of the feed remaining in said feed storage of each said plurality of time actuated feeding stations is less than a predeterminable threshold volume.

18. The autonomous animal feeding station system of claim 17, wherein said autonomous functions include a metering tray at a bottom of said feed storage of each said feeding station for dispensing the feed at predeterminable volumes.

19. The autonomous animal feeding station system of claim 17, wherein said central control unit includes a camera for recording the surrounding area of said plurality of time actuated feeding stations.

20. The autonomous animal feeding station system of claim 17, wherein said predeterminable intervals are predeterminable times.
